(19) United States
(12) Patent Application Publication
(10) Pub. No.: US 2025/0202789 A1
(43) Pub. Date: Jun. 19, 2025

(54) DEVICE AND METHOD FOR ROUTING FLOWS IN TIME-SENSITIVE NETWORKS

(71) Applicant: COMMISSARIAT A L’ENERGIE ATOMIQUE ET AUX ENERGIES ALTERNATIVES, PARIS (FR)

(72) Inventors: Siwar BEN HADJ SAID, GIF SUR YVETTE (FR); Michael BOC, GIF SUR YVETTE (FR)

(21) Appl. No.: 18/864,889

(22) PCT Filed: May 4, 2023
(86) PCT No.: PCT/EP2023/061786

§ 371 Date: Nov. 11, 2024

(30) Foreign Application Priority Data
May 20, 2022 (FR) 2204878

(51) Int. Cl. H04L 43/0852; H04L 45/121; H04L 47/2425

(52) U.S. Cl. CPC H04L 43/0852; H04L 45/121; H04L 47/2433

(57) ABSTRACT

A method is provided for routing a data flow in a time-sensitive deterministic network, in order to route the packets of a data flow from a sender terminal to a receiver terminal, the network including switches for transmitting the packets, the switches being configured to implement predefined transmission scheduling over repeated time cycles having fixed-length time slots. The routing method uses the latency of a path as a metric to compute the k shortest paths between a sender terminal and a receiver terminal, and then, for each path, determines, for each switch located on this path, a tolerance interval that defines the amount of time for which the packets of a flow are able to wait at the switch before being transferred to the following switch, without exceeding the deadline for arrival of each packet of the flow at its destination, in order to reserve available slots.

### CROSS-REFERENCE TO RELATED APPLICATIONS

This application is a National Stage of International patent application PCT/EP2023/061786, filed on May 4, 2023, which claims priority to foreign French patent application No. FR 2204878, filed on May 20, 2022, the disclosures of which are incorporated by reference in their entireties.

### FIELD OF THE INVENTION

The present invention is in the field of telecommunications networks, and relates more particularly to a method for routing multi-QoS flows in deterministic networks or time-sensitive networks (TSN).

### BACKGROUND

TSN is a set of standards, defined by the IEEE 802.1 Working Group, that extend the Ethernet network in order to meet the stringent requirements of real-time communications.

This type of network is intended to be used mainly in industrial networks, intra-vehicle networks and 5G/6G core networks. By extending and adapting the existing Ethernet standards, TSN creates a convergence between information technology (IT) and industrial operational technology (OT) in industrial networks. This means that real-time critical data and data-intensive applications are able to be implemented over a common Ethernet cable without interfering with one another.

The TSN specifications provide deterministic services, enabling real-time transmission of data within a foreseeable framework within a known time span in industrial environments, such as machine control applications in production processes, from sensor to cloud. TSN offers a guaranteed latency (the time required for a data packet to pass from the source to the destination through a network) and a guaranteed quality of service with time synchronization.

The various documents of the TSN standard offer a complete real-time communication solution when used together in collaboration. Each standard specification is autonomous and may be used on its own. The specifications may be grouped into three categories:
Time synchronization, corresponding to the IEEE 802.1AS standard, in which all peripherals participating in real-time communication must have a common understanding of time.
Scheduling, corresponding to the IEEE 802.1Qbv standard, for formatting TSN traffic, in which all peripherals participating in real-time communication comply with the same rules in terms of processing and transmitting communication packets.
Routing or selection of communication paths, path reservations and fault tolerance, in which all peripherals participating in real-time communication comply with the same rules in terms of selecting communication paths and in terms of reserving bandwidth and times, possibly using multiple simultaneous paths to achieve fault tolerance.

The mechanism for controlling TSN traffic may then be considered in two aspects: (1) Qbv scheduling, which makes it possible to define which frame of a flow is to be sent and when to send it; and (2) routing, corresponding to the selection, for each flow, of a path from the source to the destination.

To implement scheduling, certain formulas or restrictions complying with the time requirements are introduced. They are generally solved as optimization problems by applying integer linear programming (ILP) or as decision problems by applying satisfiability modulo theories (SMT). The search for a scheduling method is thus tantamount to solving a problem of “NP-hard” complexity.

As a result, it becomes excessively complex, in order to comply with the computation time limit of large-scale networks, to attempt to jointly solve the two aspects, i.e. scheduling and routing.

One typical solution consists in first solving the routing problem, followed by the scheduling problem.

In one common approach, the routing is computed along the shortest path in terms of number of hops. Next, once the routes have been determined, the Qbv schedule is computed on the basis of these routes.

This approach is not optimum in the sense that the computing of the routes does not take into consideration the constraints of the flows in terms of latency, nor the fact that Qbv scheduling is in progress on the switches forming the TSN network.

Qbv scheduling proposes a mechanism for ensuring limited latencies. It allows the switches of a TSN network to control traffic in switch output port queues in accordance with a predefined transmission schedule (the IEEE 802.1Qbv time scheduler), and thus makes it possible to guarantee the quality of priority traffic. The IEEE 802.1Qbv time scheduler is designed to separate communication on the Ethernet network into repeated fixed-length time cycles. Within these cycles, various time slices may be configured and assigned to one or more of the eight Ethernet priorities.

The switches serve as intermediaries between data flow sender terminals (talkers) and receiver terminals (listeners), by managing the multiplexing of data, that is to say the reception, processing and retransmission thereof.

FIG. 1 illustrates, in schematic and simplified form, a TSN network formed of a plurality of source equipments (T1, T2, T3) and of a destination equipment (L1) that are connected to switches (S1, S2, S3, S4, S5) via Ethernet links.

In this example, it will be considered that three TSN flows (ST3, ST4, ST5) going to the same destination (L1) have latency constraints, for example a maximum latency of 200 μs for the flow ST3 (latencyMax3=200 μs), a maximum latency of 10 ms for the flow ST4 (latencyMax4=10 ms) and a maximum latency of 500 μs for the flow ST5 (latencyMax5=500 μs).

According to the abovementioned common approach, these three flows will take the same route (that is to say the shortest path, for example via the switches S2 and S3), and then the scheduler will decide on a new cycle integrating three time ranges (or time slots) for these three flows. However, when the cycle (computed on the output port of the switch S3 connected to the destination terminal L1) might not include all of the flows, since it becomes full, as illustrated in FIG. 1, in which the cycle distributes remaining time ranges for the flows ST1 to ST4 and is no longer able to take into account the flow ST5, the scheduler (that is to say the scheduling module) might decide (that is to say produce the result or the information) that the configuration of the system is unfeasible.

Thus, in this simplified example, it becomes apparent that, using the common approach, considering only the number of hops (the shortest path) when computing the routes may conclude in the selection of one and the same route for all flows, and may therefore lead to complexity in terms of computing the Qbv schedule, or even to it being impossible to schedule the transmission of certain flows.

In addition, this common approach is not suitable for the new scenarios envisaged, such as reconfigurable production lines in Industry 4.0, having a 5G core based on a TSN network. This is because, in these types of scenario, the system is said to be open since the flows are not all known in advance before the network is deployed, and the Qbv scheduling mechanism is then subject to reconfigurations in order to be able to meet the application requirements of critical flows. In these systems, in order to guarantee the precision of a manufacturing process and minimize any defect, devices such as robots, actuators and sensors have to communicate rapidly with one another since they have to react very quickly depending on the command and control system, or depending on certain unexpected events.

Therefore, in order to be able to respond to scenarios envisaged in Industry 4.0 in which production lines are reconfigurable (this implying dynamics in the industrial network), or in order to respond to the scenario in which TSN technology is integrated into the 5G/6G core in which the flows are not known in advance, there is a need for algorithms that meet the stringent requirements of real-time communications.

There are a few approaches that partially address these problems.

The IEEE 802.1Qcc standard provides two main approaches (a centralized approach and a distributed approach) for configuring TSN mechanisms (IEEE, “IEEE Standard for Local and Metropolitan Area Networks-Bridges and Bridged Networks Amendment 31: Stream Reservation Protocol (SRP) Enhancements and Performance Improvements”), IEEE 802.1Qcc-2018. In this standard, it is emphasized that the centralized approach is the preferred one for providing the configuration of IEEE 802.1Qbv. However, this standard does not provide algorithms that make it possible to decide on routes and generate the configuration of the gate configuration lists (GCL) to be deployed in the network.

In the literature, the main approach is generally based on engineering tools: simulation tools such as “RTaW-Pegase” or else mathematical optimization tools such as ILP (integer linear programming) formulations or SMT (satisfiability modulo theories) solvers.

However, these engineering tools do not make it possible to cater for the aspect of the dynamics expected by all new scenarios envisaged in the future, such as that of open systems in which the arrival of the flows is not known in advance.

For example, the article by Nayak, N. G., Duerr, F., & Rothermel, K. (2018), Routing algorithms for IEEE802. 1Qbv networks, ACM SIGBED Review, 15(3), 13-18, proposes a routing algorithm based on the ILP technique that aims to reduce the number of flows to be scheduled in each switch. However, the main drawback of this type of technique is the execution time, which is not suitable for dynamically managing and configuring a TSN network.

The articles by Singh, S. (2017), Routing algorithms for time sensitive networks (Masters thesis), and by Ojewale, M. A., & Yomsi, P. M. (2020), Routing heuristics for load-balanced transmission in TSN-based networks, ACM Sigbed Review, 16(4), 20-25, have proposed routing heuristics that consider the maximum amount of traffic to be scheduled (“maximum scheduled traffic load MSTL”) as a route computation metric. Next, to schedule the flows, Singh, S. uses the satisfiability modulo theory (SMT solver). The routing algorithm aims to minimize this metric in order to find the path for each of the flows.

The drawback of the routing algorithms proposed in the literature is that they decide on routes on the basis only of the amount of traffic to be scheduled, without taking into account latency constraints associated with these flows. Thus, with this type of routing algorithm, flows having stringent constraints in terms of latency might, in spite of everything, take longer paths and, as a result, their latency constraints would not be complied with.

Another known approach is described in the article by Huang, K., Wu, J., Jiang, X., Xiong, D., Huang, K., Yao, H., . . . & Liu, Z. (2020), A period-aware routing method for IEEE 802.1 Qbv TSN networks, Electronics, 10(1), 5, which proposes a routing algorithm that takes into consideration the period of the flows. First of all, the algorithm makes it possible to organize the flows in accordance with a flow combinability metric, which reflects the ability of the flows to be brought together in the same schedule. Second of all, the routing algorithm is based on a cost metric computed using the following equation:

Cost=MSOW+K*hops,

where the parameter ‘MSOW’ is a metric invented by the authors to measure the combinability of the flows, the parameter ‘hops’ represents the length of the path, and the parameter ‘K’ is a weight defined by the user to penalize the length of the path with respect to the parameter ‘MSOW’. The drawback of this solution lies in the choice of the parameter ‘K’, which, depending on its value, may impact the performance of the algorithm. Moreover, this algorithm does not take into consideration the constraints of the flows in terms of latency.

Therefore, there is no known routing algorithm solution for time-sensitive networks that takes into account latency constraints of flows while at the same time complying with the application requirements of these flows, such as the just-in-time arrival requirement.

### SUMMARY OF THE INVENTION

The present invention addresses these various needs.

One subject of the present invention is a method and a device for implementing said method that make it possible to compute the routing of flows in deterministic networks.

Advantageously, the method of the invention, in addition to considering the Qbv schedule that is already configured in the switches forming part of the paths, considers latencies of the data flows as metrics for determining the routing paths.

Unlike known routing methods, the proposed solution introduces a tolerance interval that will give more flexibility to the scheduler with regard to determining time slots to be allocated to the flows, when a Qbv schedule is already configured on the switches.

The present invention may be implemented in industrial networks (fields of plants of the future, Industry 4.0/highly reconfigurable plants), intra-vehicle networks (fields of vehicles of any type: motor vehicles, trucks, buses, trains, boats, etc.), or else in the 5G/6G network core (for conveying real-time communications).

In order to obtain the desired results, what is proposed is a method for routing a data flow in a time-sensitive deterministic network, in order to route the packets of a data flow from a sender terminal to a receiver terminal, the network comprising switches for transmitting the packets, said switches being configured to implement predefined transmission scheduling over repeated time cycles having fixed-length time slots, the method being computer-implemented and comprising the following steps:

generating, taking into account a path latency parameter, a set of ‘k’ shortest paths between the sender terminal and the receiver terminal;

for a path ‘m’ from among the ‘k’ paths:
computing, for each switch of this path, a tolerance interval over the duration of the cycle, the tolerance interval defining a duration for which the packets of said data flow are able to remain at said switch before being transmitted, without exceeding a deadline for arrival at the receiver terminal;
determining whether a time slot is able to be reserved on the predefined cycle for each switch, and if so selecting this path to route said data flow; or
if there are one or more switches not having a time slot that is able to be reserved, determining whether a time slot may be available within the tolerance interval computed for each switch, and if so selecting this path to route said data flow, or if not iterating the preceding steps of computing a tolerance interval and of determining a time slot for another path ‘m+1’ from among the ‘k’ paths.

The invention may be implemented in accordance with alternative or combined embodiments, in which:
the step of generating the ‘k’ shortest paths consists in implementing a Yen algorithm.
the path latency parameter is computed based on the propagation delay and the average residence time of the packets at a switch.
the tolerance interval is computed on the basis of an equitable distribution between all of the switches of the path.
the tolerance interval is computed depending on the load of each switch of the path, and consists in assigning a larger tolerance interval to switches that are more loaded. the method comprises steps of delaying the sending of packets for switches that are more loaded, and of speeding up the sending of the packets for switches that are less loaded.
the method comprises a step of cancelling time slot reservations made on switches preceding a switch for which there is no time slot available within the tolerance interval.
the method comprises a preliminary step of synchronizing all of the switches and all of the terminals connected to the TSN network with one another.

The invention also relates to a device for routing data flows in a time-sensitive deterministic network, in order to route the packets of a data flow from a sender terminal to a receiver terminal, the network comprising switches for transmitting the packets, said switches being configured to implement predefined transmission scheduling over repeated time cycles having fixed-length time slots, the device comprising means for implementing the steps of the method of the invention.

Advantageously, the method of the present invention may be implemented in the two network management infrastructures presented in the IEEE 802.1Qcc standard, namely the centralized infrastructure and the distributed infrastructure.

In one embodiment for the centralized approach, the method is carried out on the central controller CNC (central network controller).

In one embodiment for the distributed approach, each switch of a TSN network determines the allocation of time slots and publishes this allocation to its neighbors.

The invention also relates to a computer program product comprising code instructions for carrying out the steps of the method of the invention when the program is executed on a computer.

### DESCRIPTION OF THE DRAWINGS

FIG. 1 is a simplified example for illustrating the problem of routing in a TSN network.

Other features and advantages of the invention will become apparent from the following description and the figures of the appended drawings, in which;

FIG. 2 illustrates the measurement of the propagation delay between two nodes of a TSN network;

FIG. 3 illustrates the exchanges between nodes of a TSN network in order to synchronize the clocks;

FIG. 4 illustrates the identification of time slots available within a tolerance interval, according to one embodiment of the invention;

FIG. 5 illustrates, in a simplified example, the implementation of the routing method of the invention in a TSN network;

FIG. 6a and FIG. 6b are a flowchart of the steps of the method for determining a routing path according to one embodiment of the invention;

FIG. 7a illustrates a TSN network environment in accordance with an IEEE 802.1Qcc centralized approach, making it possible to implement the method of the invention;

FIG. 7b illustrates a TSN network environment in accordance with an IEEE 802.1Qcc distributed approach, making it possible to implement the method of the invention.

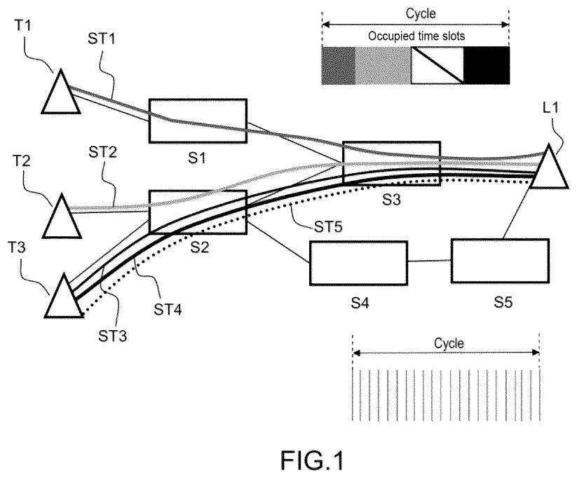

### DETAILED DESCRIPTION

The detailed description is given for a deterministic TSN network environment in accordance with the IEEE 802.1 standard and the associated standards. In the description, the various terms used with an acronym, such as Qbv, Qcc, AS, etc., should be understood as denoting said term in accordance with the corresponding standard for the IEEE 802.1 standard. Thus, for example, the Qbv cycle signifies the cycle as defined by the IEEE 802.1Qbv standard.

It should be noted that the expressions ‘time range’ and ‘time slot’ are used indiscriminately to refer to a duration for which temporal resources are allocated.

In order for the scheduling to be able to cater for the limited latencies required in the context of deterministic networks, all of the TSN switches and the terminals connected to a TSN network are considered to be perfectly synchronized with one another, in particular in accordance with the IEEE 802.1AS standard.

According to the TSN principles known to those skilled in the art, one node of the network acts as master (GM), the grandmaster, the other nodes acting as slave nodes. The GM may be elected by a human or by an algorithm, such as for example the “Best Master Clock Algorithm” (BMCA).

The IEEE 802.1AS standard allows TSN devices (that is to say of the TSN network) to synchronize their clocks with the reference clock of a GM. The known “Precision Time Protocol” (PTP) protocol and its enhanced version, the “Generalized Precision Time Protocol” (gPTP) protocol, are used to synchronize the clocks. This protocol aims to ensure that the application requirements in terms of time synchronization are achieved. It has the role of synchronizing the terminals and the switches belonging to the same domain.

This protocol is established in line with the principle of master clock and slave clocks. The master clock serving as a time reference is called a “reference clock”, and its time may possibly be synchronized (via GPS, NTP, etc.) to a clock called a global clock.

The GM advertises its presence regularly. It sends, at a configured frequency, its clock to the slaves so that they are able to synchronize their clock to that of the GM. The operation in the standard is based on the exchange of synchronization information such as timestamps that timestamp the sending and reception of gPTP (or PTP) messages.

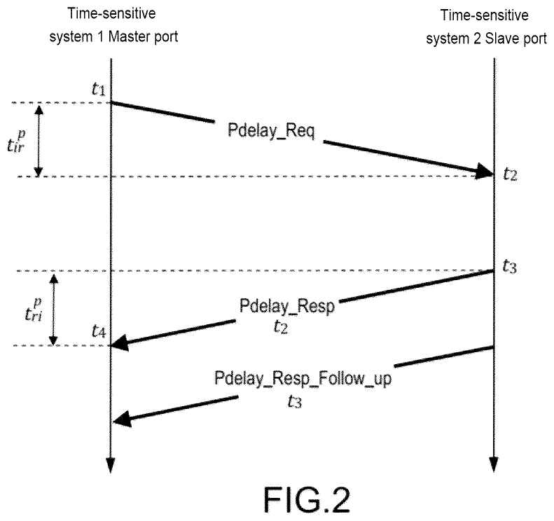

To ensure precise temporal synchronization, the IEEE 802.1AS standard proposes to measure the propagation delay between two nodes of a TSN network as follows, as illustrated in FIG. 2:

The master port of a first system of the TSN network (“time-aware system 1”) sends a delay request message ‘Pdelay_Req’, while at the same time capturing the sending timestamp ‘t1’.

The term “time-aware system” is defined in the IEEE 802.1AS standard as being “a device that contains one or more PTP Instances and/or PTP services (e.g., Common Mean Link Delay Service)”. This definition means that it is then an equipment that is capable of participating in time synchronization as defined in the IEEE 802.1AS standard, that is to say an equipment capable of carrying out hardware timestamping and of exchanging time messages with its neighbors.

Upon receipt of the message ‘Pdelay_Req’, the slave port of a second system of the TSN network (“time-aware system 2”) retrieves the reception timestamp ‘t2’ of the message.

The slave port of the second system “time-aware system 2” sends a response message ‘Pdelay_Resp’ containing the reception timestamp ‘t2’, and retrieves the sending timestamp ‘t3’ of this response message ‘Pdelay_Resp’.

The master port of the first system “time-aware system 1” receives the response message ‘Pdelay_Resp’ and captures the reception timestamp ‘t4’.

The slave port of the second system “time-aware system 2” sends a follow-up message ‘Pdelay_Resp_Follow_Up’ containing the sending timestamp ‘t3’ of the previous response message ‘Pdelay_Resp’.

At the end of this exchange of three messages, the first system “time-aware system 1” has four timestamps (t1, t2, t3, t4), which will make it possible to compute an average propagation delay ‘D’, using the following equation:

$$D = \frac{( t 4 - t 3 ) + ( t 2 - t 1 )}{2} .$$

The master-slave delay ‘t4-t3’ and the slave-master delay ‘t2-t1’ that are determined as the differences between the respective timestamps make it possible to compute an average delay, from which the slave knows the difference between its clock and the master clock, thereby allowing it to set its own clock.

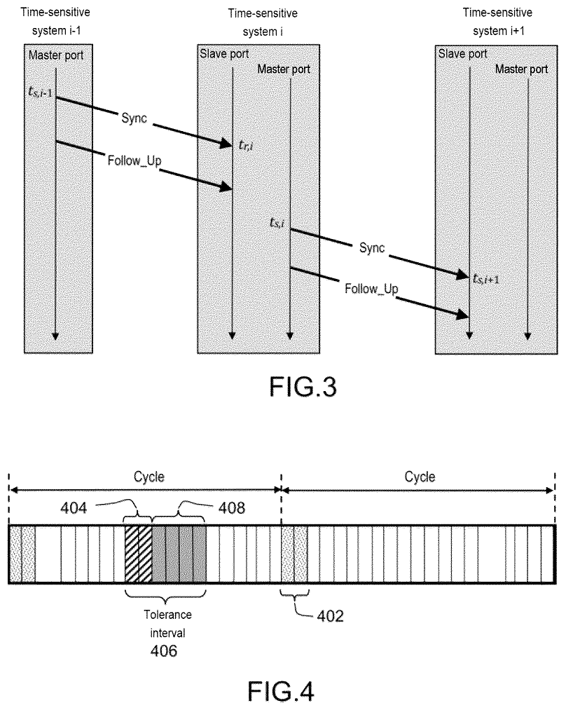

The IEEE 802.1AS standard includes a second phase of a protocol exchange that supplements the first phase and makes it possible to synchronize the clocks between multiple systems of a time-sensitive network. FIG. 3 illustrates this exchange on three systems (i-1, i, i+1).

The master port of the first system ‘i-1’ (“time-aware system i-1”) sends a synchronization message ‘Sync’ to a slave port of a second system ‘i’ (“time-aware system i”), while at the same time capturing the sending timestamp ‘t (s,i-1)’.

The slave port of the second system ‘i’ (“time-aware system i”) receives the synchronization message ‘Sync’ and captures the corresponding reception timestamp ‘t (r,i)’.

The master port of the first system ‘i-1’ (“time-aware system i-1”) sends, to the slave port of the second system ‘i’, a follow-up message ‘Follow_Up’ containing the sending timestamp ‘t (s,i-1)’ of the preceding synchronization message.

A master port of the second system ‘i’ (“time-aware system i”) may in turn send the synchronization message ‘Sync’ to a slave port of a third system ‘i+1’ (“time-aware system i+1”), while at the same time capturing the corresponding sending timestamp ‘t (s,i)’.

The slave port of the third system ‘i+1’ (“time-aware system i+1”) receives the synchronization message ‘Sync’ and captures the corresponding reception timestamp ‘t (r,i+1)’.

The master port of the second system ‘i’ (“time-aware system i”) sends, to the slave port of the third system ‘i+1’, the follow-up message ‘Follow_Up’ containing the sending timestamp ‘t (s,i-1)’ of the first synchronization message sent by the first system ‘i-1’.

In this way, the second system ‘i’ and the third system ‘i+1’ are able to synchronize to the reference clock of the first system ‘i-1’.

As indicated above, the routing method of the invention considers that all of the TSN switches and the terminals connected to the TSN network are considered to be perfectly synchronized with one another, in order to ensure the “just-in-time” property required by certain flows.

By virtue of the time synchronization that is put in place, the switches are then able to retrieve information about the latencies of the routes or paths (by retrieving the propagation delays and the average residence delay of the packets at the switches in order to determine the latency of each route or path).

The routing method of the invention aims to ensure that the packets arrive at their destination “just in time”, that is to say not before or after the deadline. Specifically, for example for closed-loop systems, the messages sent by a sensor must arrive exactly at the time when a controller has to check whether it has received a message from this sensor.

The deadline is a predefined parameter in order to meet the application requirements of the flows of the application in question, and it may be set by the operator or the designer of the application. For example, for a “sensor/PLC controller/actuator” loop, which requires a maximum latency not to be exceeded, a datum that will be recorded at the sensor must imperatively arrive at the PLC controller after a precise time. The deadline parameter may also be configured at the PLC controller, which contains a loop so as to allow it to check the arrival of a new datum sent by the sensor.

The general principle of the routing method of the invention is that of utilizing information about the network topology and data from the IEEE 802.1AS protocol in order to compute and choose routes that make it possible to minimize latencies for each flow.

The data from the IEEE 802.1AS protocol will in particular be an inter-node propagation time, an average residence time of the packets at a switch.

The routing method of the invention uses the latency of a path as a metric for selecting or not selecting this path. The method makes it possible to compute the k shortest paths between a sender terminal and a receiver terminal, and then, for each path, the method determines a tolerance interval for each hop on the route (that is to say for each switch located on this path).

The tolerance interval of a switch will make it possible to define the amount of time for which the packets of a flow that has its own latency constraint are able to wait at the switch (that is to say not be retransmitted as soon as they arrive) before being transferred to the following node of the route, without exceeding the deadline for arrival of each packet of the flow at its destination.

A tolerance interval TIᵢ^{j}, for a flow STⱼ at a switch SWᵢ is thus computed taking into account the deadline for the flow, the latency of the path and the number of hops (that is to say switches) on this path.

Advantageously, computing a tolerance interval for each switch of a path gives the scheduling module latitude with regard to choosing the time slots to be reserved for each flow.

Indeed, if a time slot that has to be reserved for a flow STⱼ at a switch SWᵢ is not available, the scheduling algorithm then takes into account the tolerance interval that has been computed for this switch, and checks whether it is able to select another time slot while remaining within the tolerance interval.

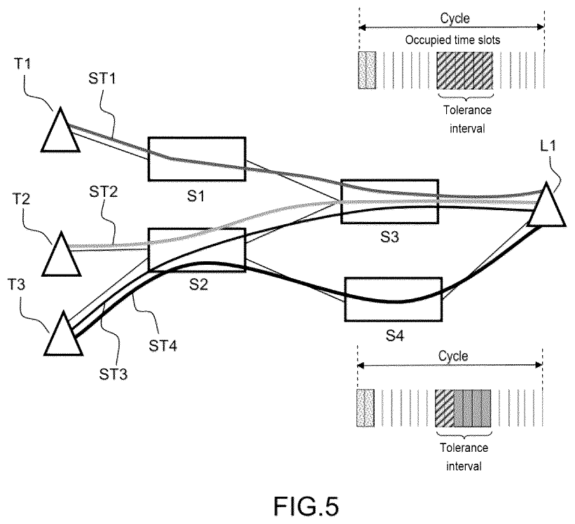

FIG. 4 illustrates, over the duration of one cycle, identification of time slots available within a tolerance interval.

In TSN networks, to allocate a time slot to a given flow, scheduling algorithms generally determine an available time slot over the entire Qbv cycle (outside the time slots 402 dedicated to network control traffic exchanged between the switches), and allocate, that is to say reserve, this slot for the flow.

FIG. 4 illustrates, in hatching, that two time slots 404 that are computed by the scheduling algorithm to be reserved for a flow are already occupied, that is to say reserved for another flow. According to the principle of the invention, the scheduling algorithm takes into account the tolerance interval 406 computed for this switch during routing, in order to determine whether other time slots are available while still remaining within the range covered by the tolerance interval. In the example of FIG. 4, subsequent new time slots may thus be assigned from among the existing available time slots 408 over the tolerance interval 406.

The routing method of the invention makes it possible, for each flow to be transmitted from a sender terminal to a receiver terminal within a TSN network, to compute at least two possible paths using the latency of each path as a metric, and then makes it possible to check the possibility of reserving time slots available within the tolerance interval that is computed for each switch located on a path.

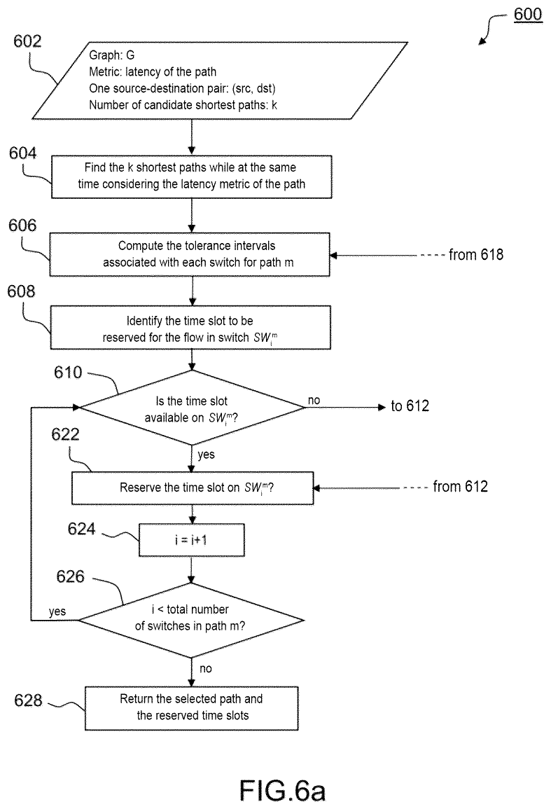

FIG. 5 illustrates one example of the implementation of the routing method of the invention in a simplified TSN network consisting of four TSN access switches (S1, S2, S3, S4). A receiver terminal L1 that is connected to the TSN network has subscribed to three sender terminals (T1, T2, T3) that are themselves connected to the TSN network. The receiver terminal receives flows (that is to say data packets) from each sender via different paths, the flows transiting via different switches.

As illustrated, a flow ST1 sent by the sender T1 is transmitted to the receiver L1 via the switches S1 and S3, a flow ST2 sent by the sender T2 is transmitted to the receiver L1 via the switches S2 and S3, and a flow ST3 sent by the sender T3 is transmitted to the receiver L1 via the switches S2 and S3.

The sender T3 has to send a new flow ST4 to the receiver L1. Implementing the routing method of the invention makes it possible to determine the routing path for this new flow ST4.

According to the example, the flow ST4 cannot take the same path (S2/S3/L1) as the path computed for the flow ST3 coming from the same sender terminal T3 and cannot take the same path (S2/S3/L1) as the path computed for the flow ST2 coming from the sender terminal T2, since there are no further time slots available in the cycle for this switch S3 (illustrated in the cycle diagram at the top).

Therefore, the routing method of the invention, after having determined that the computed first path (S2/S3/L1) is not able to be reserved for the flow ST4, will compute an alternative path to search for a switch other than S3 having available time slots, while at the same time complying with the tolerance interval.

In the illustrated example, the switch S4 has available time slots that may be assigned to the flow ST4 (illustrated in the cycle diagram at the bottom). The method then makes it possible to determine that the new flow ST4 is able to be routed from the sender terminal T3 to the receiver terminal L1, passing successively via the switch S2 and then the switch S4 along a route (T3/S2/S4/L1).

Those skilled in the art will understand that FIG. 5 is given to provide a simplified illustration of the principle of the method of the invention, but that said method may be implemented on a TSN network comprising a plurality of sender terminals, receiver terminals, switches, and for numerous flows to be routed.

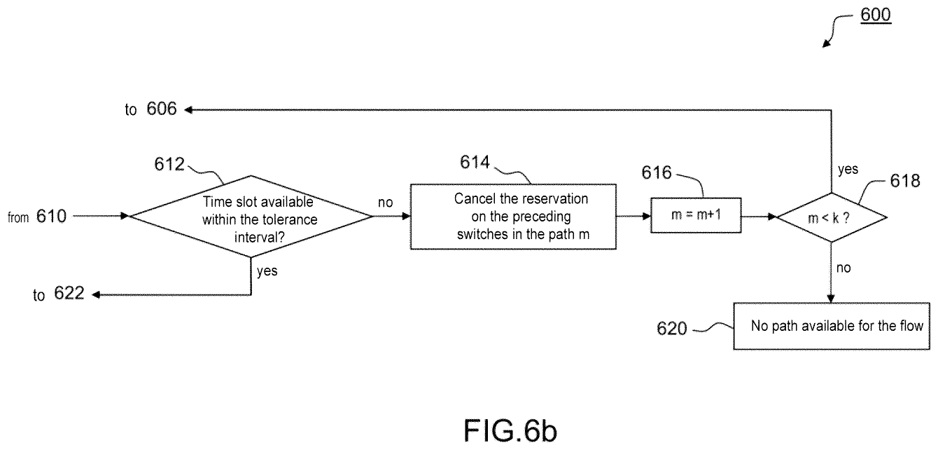

FIG. 6a and FIG. 6b illustrate, in a flowchart, one embodiment of steps of the routing method 600 of the invention, applied to the routing of a new flow.

Step 602: in an initial step, the method makes it possible to establish or retrieve the configuration of the network, in the form of a graph G identifying the source node (src: sender terminal), the destination node (dst: receiver terminal), the intermediate nodes (the switches able to connect the source to the destination), and the links between the nodes. The method makes it possible, in this initial step, to define the number k of shortest paths to be computed, and to define the latency of the path as a metric for the computation. This metric may be computed based on the propagation delay and the average residence time of the packets at the switch, which values may be provided by the IEEE 802.1AS standard.

Step 604: in a following step, the method makes it possible to compute, for this graph, the ‘k’ shortest paths taking into account the latency metric.

In one embodiment, the well-known Yen algorithm is used to find the ‘k’ shortest paths.

The method then enters a computing loop for each path ‘m’ from among the ‘k’ shortest paths.

Step 606: the method makes it possible to compute tolerance intervals TIᵢ^{j} associated with each switch of the path ‘m’.

In one embodiment, the tolerance interval is computed on the basis of an equitable distribution, between all of the switches that are located on a path between a sender and a receiver, of a global budget in terms of latency that is tolerated (by application flows).

The tolerance interval TIᵢ^{j} for a flow STⱼ at a switch SWᵢ is computed using the following equation:

$${TI}_{i}^{j} = \frac{deadline {ST}_{j} - latency of the path {ST}_{j}}{number of hops} .$$

In another embodiment, the global budget in terms of tolerated latency may be distributed non-equitably, and be allocated according to various criteria, for example depending on the load of each switch of the path.

In this embodiment, the tolerance interval may be computed using the following equation:

$${TI}_{i}^{j} = {α}_{i} ( \frac{deadline {ST}_{j} - latency of the path {ST}_{j}}{\sum {α}_{i}} )$$

where aᵢ represents the loading coefficient of the switch SWᵢ.

The loading coefficient may be computed using the following equation:

$${α}_{i} = \frac{{NbFlow}_{i}}{{max ( {NbFlow}_{i} )}_{i}}$$

where NbFlowᵢ represents the number of flows arriving at the switch SWᵢ, and max (NbFlowᵢ) represents the loading of a path as a function of the number of flows arriving at the switches forming part of this path.

In a scenario in which a first switch on a route that has been computed for the sending of a flow (as being one route of the ‘k’ shortest paths) is relatively highly loaded, the method makes it possible to assign, to this first switch, a tolerance interval larger than those of the other switches. The first switch will thus be able to be configured to delay the sending of the packets of the flow in question, whereas the rest of the switches will be configured to speed up the sending of these packets so as not to add latencies to the path.

Step 608: the following step consists in identifying a time slot to be reserved for the new flow in each switch swim of the path ‘m’.

Step 610: the method makes it possible to determine whether a time slot is available and able to be reserved in each switch SWᵢ^{m} of the path ‘m’.

Step 612: if there is no time slot available on the switch swᵢ^{m}, the method makes it possible to check whether a time slot may be available considering the tolerance interval that has been computed for this switch.

Step 614: if it is not possible to reserve a time slot within the tolerance interval on the switch SWᵢ^{m}, then the path ‘m’ is not a route that allows the flow in question to be routed, and the method makes it possible to cancel the time slot reservations made on the preceding switches.

Step 616: the method makes it possible to move to the following path “m=m+1” in the list of the ‘k’ shortest paths.

Step 618: the method makes it possible to check whether all of the ‘k’ paths have been processed. If some paths have not yet been processed, the method returns to step 606 to compute tolerance intervals for each switch associated with the following path to be processed.

Step 620: if all of the paths have been processed, and if it has not been possible to reserve time slots for routing the new flow, the method ends, indicating that no path is available to process the new flow.

Step 622: returning to step 610, if a time slot is available on the switch SWᵢ^{m} of the path ‘m’, the method makes it possible to reserve this time slot.

Step 624: the method makes it possible to move to the following switch on the path ‘m’.

Step 626: the method makes it possible to check whether all of the switches of the path ‘m’ currently being analyzed have been processed. If all of the switches of the path ‘m’ have not been processed, the method loops back to step 610 to determine whether it is possible to reserve time slots in the following switch, and continues with the described steps.

Step 628: if all of the switches have been processed, meaning that it was possible to assign time slots in all of the switches of the path ‘m’, the method ends, indicating the path selected to process the new flow.

In one embodiment, step 608 for identifying whether time slots are able to be reserved in a switch is carried out in accordance with the method described in patent application FR 2112233 from the Applicant.

In order to configure and manage TSN networks, the IEEE 802.1Qcc standard mainly proposes two approaches: a centralized approach and a distributed approach. The described method may be implemented in each of these two configurations.

### Centralized Approach:

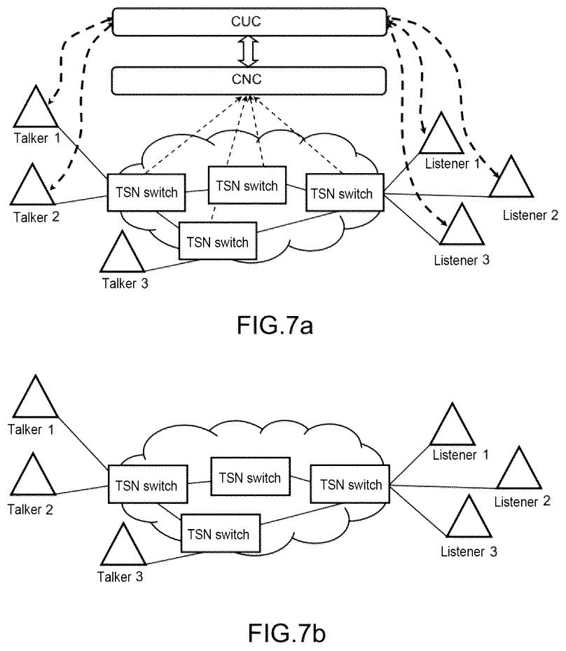

The centralized approach provided by the IEEE 802.1Qcc standard is illustrated by FIG. 7a, in which the set of TSN switches of the network is controlled, managed and configured by a centralized CNC (centralized network configuration) entity. The terminals (talkers/listeners) that will use the TSN network provide the characteristics of their flows to a CUC (centralized user configuration) entity using third-party software (middleware), such as for example OPC UA, ROS, DDS, etc. The CUC entity has the role of grouping together requests from the terminals/applications to use the TSN network and of providing them to the CNC entity. The requests are analyzed by the CNC while at the same time having information about the current capacities of the TSN network. If it is possible to reserve resources for new flows, the CNC responds to the CUC that these terminals/applications are able to use the network. The CNC may also provide these terminals/applications with the slot to be used (that is to say when to start using the network). For example, it may ask an application to start sending its data in x milliseconds. If it is impossible to reserve resources for certain flows, the CNC rejects the requests associated with these flows. In this approach, the method of the invention may be implemented and carried out at the CNC.

### Distributed Approach:

In the case of distributed network management, as illustrated in FIG. 7b, an initial phase is necessary, in which TSN access switches have to exchange messages with one another in order to converge on a distribution of time slots. Once convergence has been achieved, each of the access switches allocates a time slot for the new flow from among the time slots associated therewith, and then propagates this information to the TSN core network switches so that they integrate this new reservation.

1. A method for routing a data flow in a time-sensitive deterministic network, in order to route the packets of a data flow from a sender terminal to a receiver terminal, the network comprising switches for transmitting the packets, said switches being configured to implement predefined transmission scheduling over repeated time cycles having fixed-length time slots, the method being computer-implemented and comprising the following steps:
generating, taking into account a path latency parameter, a set of ‘k’ shortest paths between the sender terminal and the receiver terminal;
for a path ‘m’ from among the ‘k’ paths:
computing, for each switch of this path, a tolerance interval over the duration of the cycle, the tolerance interval defining a duration for which the packets of said data flow are able to remain at said switch before being transmitted, without exceeding a deadline for arrival at the receiver terminal;
determining whether a time slot is able to be reserved on the predefined cycle for each switch, and if so selecting this path to route said data flow; or
if there are one or more switches not having a time slot that is able to be reserved, determining whether a time slot may be available within the tolerance interval computed for each switch, and if so selecting this path to route said data flow, or if not iterating the preceding steps of computing a tolerance interval and of determining a time slot for another path ‘m+1’ from among the ‘k’ paths.

2. The method as claimed in claim 1, wherein the step of generating the ‘k’ shortest paths consists in implementing a Yen algorithm.

3. The method as claimed in claim 1, wherein the path latency parameter is computed based on the propagation delay and the average residence time of the packets at a switch.

4. The method as claimed in claim 1, wherein the tolerance interval is computed on the basis of an equitable distribution between all of the switches of the path.

5. The method as claimed in claim 1, wherein the tolerance interval is computed depending on the load of each switch of the path, and consists in assigning a larger tolerance interval to switches that are more loaded.

6. The method as claimed in claim 5, comprising steps of delaying the sending of packets for switches that are more loaded, and of speeding up the sending of the packets for switches that are less loaded.

7. The method as claimed in claim 1, comprising a step of cancelling time slot reservations made on switches preceding a switch for which there is no time slot available within the tolerance interval.

8. The method as claimed in claim 1, comprising a preliminary step of synchronizing all of the switches and all of the terminals connected to the TSN network with one another.

9. A computer program product, said computer program comprising code instructions for carrying out the steps of the method as claimed in claim 1, when said program is executed on a computer.

10. A device for routing data flows in a time-sensitive deterministic network, in order to route the packets of a data flow from a sender terminal to a receiver terminal, the network comprising switches for transmitting the packets, said switches being configured to implement predefined transmission scheduling over repeated time cycles having fixed-length time slots, the device comprising means for implementing the steps of the method as claimed in claim 1.

11. The use of the device as claimed in claim 10 in a time-sensitive network implementing a centralized network architecture.

12. The use of the device as claimed in claim 10 in a time-sensitive network implementing a distributed network architecture.

13. The use of the device as claimed in claim 10 in a time-sensitive deterministic TSN network implementing a centralized or distributed network architecture by means defined in accordance with the specifications of the IEEE 802.1 Qcc standard.
